(19) United States
(12) Patent Application Publication
(10) Pub. No.: US 2026/0126575 A1
(43) Pub. Date: May 7, 2026

(54) LENS, IMAGE DISPLAY DEVICE, AND VIRTUAL REALITY DISPLAY APPARATUS

(71) Applicant: FUJIFILM Corporation, Tokyo (JP)

(72) Inventors: Naoyoshi YAMADA, Minamiashigara-shi (JP); Shinpei YOSHIDA, Minamiashigara-shi (JP)

(73) Assignee: FUJIFILM Corporation, Tokyo (JP)

(21) Appl. No.: 19/409,794

(22) Filed: Dec. 5, 2025

Related U.S. Application Data
(63) Continuation of application No. PCT/JP2024/022521, filed on Jun. 21, 2024.

(30) Foreign Application Priority Data
Jul. 10, 2023 (JP) 2023-113176
Feb. 21, 2024 (JP) 2024-024329

(51) Int. Cl. G02B 5/30; G02B 27/00

(52) U.S. Cl. CPC G02B 5/3016; G02B 27/0018

(57) ABSTRACT

A lens, image display device, and virtual reality display apparatus are provided that suppress ghosting when used in a pancake-lens VR system. The lens includes a retardation layer that converts circularly polarized light into linearly polarized light. The retardation layer includes first and second optically anisotropic layers having reverse wavelength dispersibility, and at least one of these layers is formed by immobilizing a twistedly aligned liquid crystal compound with a helical axis in the thickness direction. The image display device includes an image display panel, an absorptive polarizer, and the retardation layer in this order. The virtual reality display apparatus includes the lens or the image display device.

### CROSS-REFERENCE TO RELATED APPLICATIONS

This application is a Continuation of PCT International Application No. PCT/JP2024/022521 filed on Jun. 21, 2024, which claims priority under 35 U.S.C. § 119 (a) to Japanese Patent Application No. 2023-113176 filed on Jul. 10, 2023 and Japanese Patent Application No. 2024-024329 filed on Feb. 21, 2024. The above applications are hereby expressly incorporated by reference, in their entirety, into the present application.

### BACKGROUND OF THE INVENTION

### 1. Field of the Invention

The present invention relates to a lens, an image display device, and a virtual reality display apparatus.

### 2. Description of the Related Art

A virtual reality display apparatus is a display device which can obtain a realistic effect as if entering a virtual world by wearing a dedicated headset on a head and visually recognizing a video displayed through a composite lens.

It has been known that the virtual reality display apparatus includes an image display device and a Fresnel lens, but a distance from the image display device to the Fresnel lens is large, and thus a headset is thick and has poor wearability, which are problems.

Therefore, as disclosed in JP2020-519964A and U.S. Pat. No. 10,394,040B, a lens configuration of a composite lens called a pancake lens has been proposed, the lens configuration including an image display device, a half mirror, a retardation layer, and a reflective polarizer, and causing rays emitted from the image display device to reciprocate between the half mirror and the reflective polarizer to reduce a thickness of the entire headset.

The reflective polarizer herein is a polarizer having a function of reflecting one polarized light in incidence ray and transmitting the other polarized light. For example, reflected light and transmitted light by a reflective linear polarizer are linearly polarized light having polarization states orthogonal to each other. In addition, reflected light and transmitted light by a reflective circular polarizer are circularly polarized light in one turning direction and circularly polarized light in the opposite turning direction.

As the reflective linear polarizer in which the transmitted light and the reflected light are linearly polarized, for example, a film in which a dielectric multi-layer film is stretched and a wire grid polarizer have been known. In addition, as the reflective circular polarizer in which the transmitted light and the reflected light are converted into circularly polarized light, for example, a cholesteric liquid crystal layer having a light reflective layer in which a cholesteric liquid crystalline phase is fixed has been known.

### SUMMARY OF THE INVENTION

JP2020-519964A discloses a virtual reality display apparatus including an image display device, a half mirror, a first retardation layer, and a reflective linear polarizer, which are arranged in this order in a pancake lens, in order to obtain a wide field of view, low chromatic aberration, low distortion, and an excellent modulation transfer function (MTF). In addition, a configuration in which a second retardation layer is provided on a surface of the image display device is also disclosed.

The present inventors have made a virtual reality display apparatus including the pancake lens with reference to JP2020-519964A and the like, and have made a detailed examination of the performance thereof, and as a result, have found that there is room for further improvement in occurrence of ghost (double image) due to leaked light.

The present invention has been made in view of the above-described problem, and an object to be achieved by the present invention is to provide an image display device and a lens, which suppress occurrence of ghost in a case of being applied to a virtual reality display apparatus using a pancake lens. Another object to be achieved by the present invention is to provide a virtual reality display apparatus in which the occurrence of ghost is suppressed.

As a result of intensive studies repeatedly conducted by the present inventors on the above-described object, it has been found that the above-described object can be achieved by the following configurations.
[1] A lens comprising:
a retardation layer which converts circularly polarized light into linearly polarized light,
in which the retardation layer includes a first optically anisotropic layer and a second optically anisotropic layer,
the first optically anisotropic layer and the second optically anisotropic layer have reverse wavelength dispersibility, and
at least one of the first optically anisotropic layer or the second optically anisotropic layer is a layer obtained by immobilizing a twistedly aligned liquid crystal compound with a helical axis in a thickness direction.
[2] The lens according to [1],
in which both the first optically anisotropic layer and the second optically anisotropic layer are layers obtained by immobilizing a liquid crystal compound.
[3] The lens according to [2],
in which an alignment direction of the liquid crystal compound contained in the first optically anisotropic layer and an alignment direction of the liquid crystal compound contained in the second optically anisotropic layer are continuous at an interface between the first optically anisotropic layer and the second optically anisotropic layer.
[4] The lens according to any one of [1] to [3],
in which the first optically anisotropic layer is a positive A-plate, and the second optically anisotropic layer is a layer obtained by immobilizing a twistedly aligned liquid crystal compound with a helical axis in a thickness direction.
[5] The lens according to any one of claims [1] to [3],
in which both the first optically anisotropic layer and the second optically anisotropic layer are layers obtained by immobilizing a twistedly aligned liquid crystal compound with a helical axis in a thickness direction, and
a helical pitch of the first optically anisotropic layer is different from a helical pitch of the second optically anisotropic layer.
[6] The lens according to any one of [1] to [5], further comprising:
a reflective linear polarizer.
[7] The lens according to any one of [1] to [5], further comprising:
a reflective circular polarizer.
[8] The lens according to [7],
in which the reflective circular polarizer has a cholesteric liquid crystal layer.
[9] The lens according to any one of [6] to [8], further comprising:
an absorptive polarizer.
[10] A virtual reality display apparatus comprising:
an image display device; and
the lens according to any one of [1] to [3].
[11] An image display device comprising, in the following order:
an image display panel;
an absorptive polarizer; and
a retardation layer which converts circularly polarized light into linearly polarized light,
in which the retardation layer includes a first optically anisotropic layer and a second optically anisotropic layer,
the first optically anisotropic layer and the second optically anisotropic layer have reverse wavelength dispersibility, and
at least one of the first optically anisotropic layer or the second optically anisotropic layer is a layer obtained by immobilizing a twistedly aligned liquid crystal compound with a helical axis in a thickness direction.
[12] The image display device according to [11],
in which both the first optically anisotropic layer and the second optically anisotropic layer are layers obtained by immobilizing a liquid crystal compound.
[13] The image display device according to [12],
in which an alignment direction of the liquid crystal compound contained in the first optically anisotropic layer and an alignment direction of the liquid crystal compound contained in the second optically anisotropic layer are continuous at an interface between the first optically anisotropic layer and the second optically anisotropic layer.
[14] The image display device according to any one of [11] to [13],
in which the first optically anisotropic layer is a positive A-plate, and the second optically anisotropic layer is a layer obtained by immobilizing a twistedly aligned liquid crystal compound with a helical axis in a thickness direction.
[15] The image display device according to any one of [11] to [14],
in which both the first optically anisotropic layer and the second optically anisotropic layer are layers obtained by immobilizing a twistedly aligned liquid crystal compound with a helical axis in a thickness direction, and
a helical pitch of the first optically anisotropic layer is different from a helical pitch of the second optically anisotropic layer.
[16] A virtual reality display apparatus comprising:
a lens; and
the image display device according to any one of [11] to [13].
[17] A virtual reality display apparatus comprising:
the lens according to any one of [1] to [3]; and
the image display device according to any one of [11] to [13].

According to the present invention, it is possible to provide an image display device and a lens, which suppress occurrence of ghost in a case of being applied to a virtual reality display apparatus using a pancake lens. In addition, according to the present invention, it is possible to provide a virtual reality display apparatus in which the occurrence of ghost is suppressed.

### BRIEF DESCRIPTION OF THE DRAWINGS

FIG. 1 is a schematic view showing an example of a configuration of the virtual reality display apparatus according to the embodiment of the present invention.

FIG. 2 is a schematic view showing an example of a configuration of the virtual reality display apparatus in the related art.

FIG. 3 is a schematic view for describing occurrence of ghost in the virtual reality display apparatus.

FIG. 4 is a schematic view for describing occurrence of ghost in the virtual reality display apparatus.

### DESCRIPTION OF THE PREFERRED EMBODIMENTS

Hereinafter, the present invention will be described in detail. The description of configuration requirements described below may be made based on typical embodiments of the present invention, but the present invention is not limited to such embodiments. In the present specification, a numerical range expressed using “to” means a range including numerical values described before and after “to” as a lower limit value and an upper limit value.

In addition, in the present specification, “liquid crystal composition” and “liquid crystalline compound” include those which no longer exhibit liquid crystal properties due to curing or the like as a concept.

Hereinafter, the present invention will be described in detail with reference to the accompanying drawings. The description of the configuration requirements described below may be made based on representative embodiments or specific examples, but the present invention is not limited to such embodiments. Any numerical range expressed using “to” in the present specification refers to a range including the numerical values before and after the “to” as a lower limit value and an upper limit value, respectively.

In the present specification, “orthogonal” does not denote 90° in a strict sense, but denotes 90°±10°, preferably 90°±5°. In addition, “parallel” does not denote 0° in a strict sense, but denotes 0°±10°, preferably 0°±5°. Furthermore, “45°” does not denote 45° in a strict sense, but denotes 45°±10°, preferably 45°±5°.

In the present specification, “absorption axis” denotes a polarization direction in which absorbance is maximized in a plane in a case where linearly polarized light is incident. In addition, “reflection axis” denotes a polarization direction in which reflectivity is maximized in a plane in a case where linearly polarized light is incident. In addition, “transmission axis” denotes a direction orthogonal to the absorption axis or the reflection axis in a plane. Furthermore, “slow axis” denotes a direction in which refractive index is maximized in a plane.

In the present specification, a phase difference denotes an in-plane retardation unless otherwise specified, and is referred to as Re (λ). Here, Re (λ) represents an in-plane retardation at a wavelength λ, and the wavelength λ is 550 nm unless otherwise specified.

In addition, a retardation at the wavelength λ in a thickness direction is referred to as Rth (λ) in the present specification. The wavelength λ is set to 550 nm unless otherwise specified.

As Re (λ) and Rth (λ), for example, values measured at the wavelength λ with AxoScan OPMF-1 (manufactured by Opto Science, Inc.) can be used. By inputting an average refractive index ((nx+ny+nz)/3) and a film thickness (d (μm)) in AxoScan,
a slow axis orientation (°);

$$\begin{matrix}Re ( λ ) = R 0 ( λ ) ; and \\ Rth ( λ ) = ( ( nx + ny ) / 2 - nz ) \times d\end{matrix}$$

are calculated. Although R0 (λ) is displayed as a numerical value calculated by AxoScan, it means Re (λ).

In the present specification, “in-plane phase difference” and “slow axis” represent an in-plane phase difference value calculated from a change in polarization state with respect to predetermined polarization and a slow axis orientation calculated by the same method. Specifically, the in-plane phase difference and the slow axis can be obtained as follows.

That is, using KOBRA (registered trademark) 21ADH or WR (manufactured by Oji Scientific Instruments), linearly polarized light having a wavelength λ nm is incident in a normal direction of the optical film, and a transmitted light intensity is measured through an analyzer (linear polarizer disposed at a predetermined angle) after the light is transmitted through the optical film. By simulating from the transmitted light intensity measured by changing a relative angle between the optical film and the analyzer with respect to an orientation of the incident linearly polarized light in various ways, the in-plane phase difference and the slow axis orientation of the optical film are obtained.

In a case of selecting the measurement wavelength λ nm, a wavelength selective filter can be manually exchanged, or a measurement value can be converted using a program or the like to perform the measurement. Unless otherwise specified, the measurement wavelength is λ=550 nm.

According to the present measurement method, even in a case of a composite retardation plate in which an optical retardation effect changes depending on the incident polarization, the in-plane phase difference value and the slow axis orientation at each position in the plane can be measured.

A lens according to a first embodiment of the present invention includes a retardation layer which converts circularly polarized light into linearly polarized light, in which the retardation layer is a specific retardation layer described later.

An image display device according to a second embodiment of the present invention includes, in the following order: an image display panel; an absorptive polarizer; and a retardation layer which converts circularly polarized light into linearly polarized light, in which the retardation layer is a specific retardation layer described later.

A virtual reality display apparatus according to a third embodiment of the present invention includes a lens including a retardation layer which converts circularly polarized light into linearly polarized light, and an image display device including a retardation layer which converts circularly polarized light into linearly polarized light, in which at least one of the retardation layer included in the lens or the retardation layer included in the image display device is a specific retardation layer described later. In the virtual reality display apparatus according to the third embodiment, it is preferable that the above-described lens is the lens according to the first embodiment or the above-described image display device is the image display device according to the second embodiment; and it is more preferable to include both the lens according to the first embodiment and the image display device according to the second embodiment.

The “specific retardation layer” means a retardation layer which converts circularly polarized light into linearly polarized light, in which the specific retardation layer includes a first optically anisotropic layer and a second optically anisotropic layer, the first optically anisotropic layer and the second optically anisotropic layer have reverse wavelength dispersibility, and at least one of the first optically anisotropic layer or the second optically anisotropic layer is a layer obtained by immobilizing a twistedly aligned liquid crystal compound with a helical axis in a thickness direction.

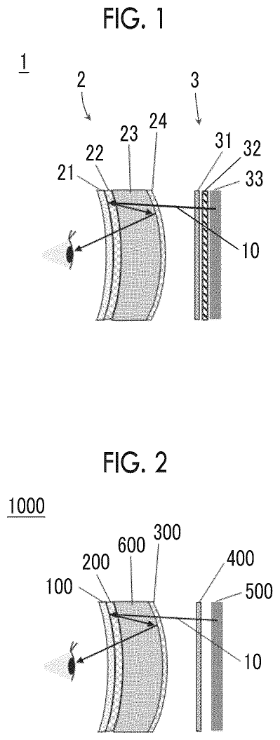

FIG. 1 schematically shows an example of a configuration of the virtual reality display apparatus according to the embodiment of the present invention.

A virtual reality display apparatus 1 shown in FIG. 1 includes a lens 2 and an image display device 3. The lens 2 includes, in the following order: a reflective linear polarizer 21; a first retardation layer 22; a lens base material 23; and a half mirror 24. In addition, the image display device 3 includes a second retardation layer 31, an absorptive polarizer 32, and an image display panel 33.

Here, in the virtual reality display apparatus 1 shown in FIG. 1, both the first retardation layer 22 and the second retardation layer 31 are the specific retardation layer.

That is, the lens 2 shown in FIG. 1 is a configuration example of the lens according to the first embodiment of the present invention; the image display device 3 is a configuration example of the image display device according to the second embodiment of the present invention; and the virtual reality display apparatus 1 is a configuration example of the virtual reality display apparatus according to the third embodiment of the present invention, in which both the retardation layer included in the lens and the retardation layer included in the image display device are the specific retardation layer.

In order to describe the operation of each embodiment of the present invention, FIG. 2 schematically shows an example of a configuration of the virtual reality display apparatus in the related art. A virtual reality display apparatus 1000 shown in FIG. 2 includes a reflective linear polarizer 100, a first retardation layer 200, a lens base material 600, a half mirror 300, a second retardation layer 400, and an image display device 500 from the left side in the drawing.

The virtual reality display apparatus 1000 can fold rays by the following mechanism to reduce a thickness of the entire headset. That is, a ray 10, which is a part of rays emitted from the image display device 500, is converted into circularly polarized light by the second retardation layer 400, transmitted through the half mirror 300, converted into linearly polarized light by the first retardation layer 200, and then incident on and reflected by the reflective linear polarizer 100. Thereafter, the ray 10 is transmitted through the first retardation layer 200 again to be converted into circularly polarized light, and reflected by the half mirror 300. In this case, the ray 10 is converted into circularly polarized light in a counterclockwise direction with respect to the circularly polarized light in a case where the ray 10 is incident on the half mirror 300. The ray 10 reflected by the half mirror 300 is transmitted through the first retardation layer 200 again to be converted into linearly polarized light, and is incident on the reflective linear polarizer 100. In this case, the ray incident on the reflective linear polarizer 100 is in a polarization state orthogonal to the polarization state in a case where the ray is incident on the reflective linear polarizer 100 for the first time, and thus the ray 10 is transmitted through the reflective linear polarizer 100 and reaches the eyes of the user. As described above, the virtual reality display apparatus 1000 can reduce the thickness of the entire headset by folding the ray 10 between the half mirror 300 and the reflective linear polarizer 100.

Among the operation of the image display device according to the second embodiment of the present invention and the operation of the virtual reality display apparatus according to the third embodiment of the present invention, first, the operation of the virtual reality display apparatus, in which the second retardation layer included in the image display device is the specific retardation layer, will be described.

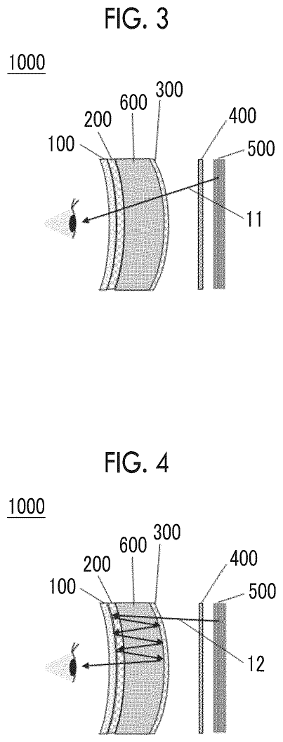

According to the studies of the present inventors, as shown in FIG. 3, in the virtual reality display apparatus 1000 in the related art, a part (ray 11) of rays emitted from the image display device 500 may be emitted without being folded between the half mirror 300 and the reflective linear polarizer 100, and may be visually recognized as a ghost image. The present inventors consider that the reason for this is that, in a case where a ray in a part of the wavelength range among the rays emitted from the image display device 500 is transmitted through the second retardation layer 400, transmitted through the half mirror 300, and then transmitted through the first retardation layer 200, the ray is not converted into complete linearly polarized light and may be converted into elliptically polarized light. The reason why the ray transmitted through the retardation layer 200 is elliptically polarized light is considered to be that an in-plane phase difference (Re) of the first retardation layer 200 and an in-plane phase difference (Re) of the second retardation layer 400 are different from each other, or slow axis orientations of the first retardation layer 200 and the second retardation layer 400 are not orthogonal to each other.

On the other hand, the image display device 3 according to the second embodiment of the present invention includes the specific retardation layer as the second retardation layer 31, together with the absorptive polarizer 32 and the image display panel 33. As will be described later, the specific retardation layer is a retardation layer which can set an in-plane phase difference to λ/4 phase difference over a wide wavelength range of visible light, and thus the second retardation layer 31 can convert linearly polarized light into circularly polarized light and can convert circularly polarized light into linearly polarized light over a wide wavelength range of visible light.

In the image display device 3 including such a second retardation layer 31, the ray 10 emitted from the image display panel 33 and transmitted through the absorptive polarizer 32, the second retardation layer 31, and the half mirror 24 is ideal circularly polarized light over a wide wavelength range in the visible range. Therefore, the ray (the ray 11 shown in FIG. 3) which is emitted without reciprocating between the reflective linear polarizer 21 and the half mirror 24 and forms a ghost image can be reduced.

Furthermore, the ray which is transmitted through the half mirror 24 for the first time and reaches the first retardation layer 22 is ideal circularly polarized light over a wide wavelength range of visible light, and does not have a polarization axis. Therefore, in a case of assembling the lens 2 including the reflective linear polarizer 21 and the first retardation layer 22, the ghost image does not increase even in a case where the slow axis orientation of the first retardation layer 22 is not orthogonal to the slow axis orientation of the second retardation layer 31. That is, in a case of manufacturing the virtual reality display apparatus 1 including the image display device 3 according to the second embodiment of the present invention, since precise angle adjustment in a case of assembling the lens 2 is not required, a lens assembly step can be significantly simplified, and thus the manufacturing cost of the virtual reality display apparatus can be reduced.

Among the operation of the lens according to the first embodiment of the present invention and the operation of the virtual reality display apparatus according to the third embodiment of the present invention, next, the operation of the virtual reality display apparatus, in which the first retardation layer included in the lens is the specific retardation layer, will be described.

According to the studies of the present inventors, as shown in FIG. 4, in the virtual reality display apparatus 1000 in the related art, a part (ray 12) of rays emitted from the image display device 500 may reciprocate two or more times between the half mirror 300 and the reflective linear polarizer 100, and may be visually recognized as a ghost image. The present inventors consider that the reason for this is that, in a case where a ray in a part of the wavelength range among rays (linearly polarized light) reflected by the reflective linear polarizer 100 is transmitted through the first retardation layer 200, the ray is not converted into complete circularly polarized light and is converted into elliptically polarized light. It is considered that, in a case where the ray emitted from the first retardation layer 200 is elliptically polarized light, the ray is reflected by the half mirror 300, and the ray transmitted through the first retardation layer 200 again includes a component parallel to a reflection axis of the reflective linear polarizer 100, and thus the ray 12 which is reflected again by the reflective linear polarizer 100 to be reciprocated is generated.

On the other hand, the lens 2 according to the first embodiment of the present invention includes the first retardation layer 22 as the specific retardation layer. As will be described later, the specific retardation layer is a retardation layer which can set an in-plane phase difference to λ/4 phase difference over a wide wavelength range of visible light, and thus the first retardation layer 22 can convert linearly polarized light into ideal circularly polarized light and can convert circularly polarized light into ideal linearly polarized light over a wide wavelength range of visible light.

In the lens 2 including such a first retardation layer 22, the linearly polarized light reflected from the reflective linear polarizer 21 is converted into ideal circularly polarized light over a wide wavelength range in the visible range in a case of being transmitted through the first retardation layer 22. Next, in a case of being reflected by the half mirror 24, the ray is converted into circularly polarized light in a counterclockwise direction with respect to the circularly polarized light in a case where the ray is incident on the half mirror 24, and this is also ideal circularly polarized light. Furthermore, the ray transmitted through the first retardation layer 22 again is converted into ideal linearly polarized light and transmitted through the reflective linear polarizer 21 with high efficiency. That is, the ray (the ray 12 shown in FIG. 4) which reciprocates two or more times between the reflective linear polarizer 21 and the half mirror 24 can be reduced, and thus the occurrence of ghost image can be suppressed.

### <Specific Retardation Layer>

The specific retardation layer used in each embodiment of the present invention will be described.

The specific retardation layer has a function of converting emitted light into linearly polarized light in a case where circularly polarized light is incident, and has a function of converting emitted light into circularly polarized light in a case where linearly polarized light is incident. In order to achieve these functions, the specific retardation layer preferably has an in-plane phase difference of λ/4 with respect to incident light having a wavelength λ. In addition, the specific retardation layer in which the in-plane phase difference is 3/4×λ or 5/4×λ can also exhibit the same function, which is preferable.

The specific retardation layer includes at least one of the first optically anisotropic layer or the second optically anisotropic layer, the first optically anisotropic layer and the second optically anisotropic layer have reverse wavelength dispersibility, and at least one of the first optically anisotropic layer or the second optically anisotropic layer is a layer obtained by immobilizing a twistedly aligned liquid crystal compound with a helical axis in a thickness direction. With such a configuration, the specific retardation layer can set the in-plane phase difference to λ/4 phase difference over a wide wavelength range of visible light. That is, the specific retardation layer can convert linearly polarized light into ideal circularly polarized light and can convert circularly polarized light into ideal linearly polarized light over a wide wavelength range of visible light.

Hereinafter, in a case of referring to features common to both the first optically anisotropic layer and the second optically anisotropic layer included in the above-described specific retardation layer, the first optically anisotropic layer and the second optically anisotropic layer will not be distinguished from each other and will be simply referred to as “optically anisotropic layer”.

In addition, the optically anisotropic layer obtained by immobilizing a twistedly aligned liquid crystal compound with a helical axis in a thickness direction and having reverse wavelength dispersibility will also be referred to as “optically anisotropic layer RT”.

In the present specification, the reverse wavelength dispersibility refers to a characteristic in which an Re value increases as a measurement wavelength increases in a case of measuring the in-plane retardation (Re) value at a specific wavelength (visible light range). It is preferable that the optically anisotropic layer satisfies Re(450)/Re(550)<1.00 and Re(650)/Re(550)>1.00.

The optically anisotropic layer having reverse dispersibility can be produced, for example, by uniaxially stretching a polymer film such as a modified polycarbonate resin film having reverse wavelength dispersibility with reference to JP2017-049574A and the like.

In addition, the optically anisotropic layer having reverse wavelength dispersibility can also be produced, for example, by aligning and immobilizing a rod-like liquid crystal compound having reverse wavelength dispersibility with reference to JP2020-084070A and the like.

As the optically anisotropic layer RT obtained by immobilizing a twistedly aligned liquid crystal compound with a helical axis in a thickness direction, a layer obtained by fixing a so-called chiral nematic phase having a helical structure, in which a twistedly aligned reverse wavelength-dispersive rod-like liquid crystal compound with a helical axis in a thickness direction is immobilized and a molecular axis of the rod-like liquid crystal compound is horizontal with respect to a surface of the optically anisotropic layer, is preferable. In a case of forming the above-described layer, it is preferable to use a mixture of a liquid crystal compound exhibiting a nematic liquid crystal phase and a chiral agent.

In the present specification, the molecular axis means a major axis (molecular major axis) in a case where the liquid crystal compound is a rod-like liquid crystal compound, or means an axis parallel to a normal direction with respect to a disc plane of a disk-like liquid crystal compound in a case where the liquid crystal compound is a disk-like liquid crystal compound.

In addition, in the present specification, “fixed” state is a state in which alignment of the liquid crystal compound is maintained. Specifically, the “immobilized” state is preferably a state in which, in a temperature range of usually 0° C. to 50° C. or in a temperature range of −30° C. to 70° C. under more severe conditions, the layer has no fluidity and a fixed alignment morphology can be stably maintained without causing a change in the alignment morphology due to an external field or an external force.

The specific retardation layer preferably includes at least one optically anisotropic layer RT in which a twisted angle of the liquid crystal compound (twisted angle of an alignment direction of the liquid crystal compound) is in a range of 85°±20°. That is, the twisted angle of at least one optically anisotropic layer RT included in the specific retardation layer is preferably 65° to 105°, more preferably 75° to 95°, and still more preferably 80° to 90°.

The “twistedly aligned liquid crystal compound” is intended to that the liquid crystal compound from one main surface to the other main surface of the optically anisotropic layer is twisted around the thickness direction of the optically anisotropic layer as an axis. Along with this, the alignment direction (in-plane slow axis direction) of the liquid crystal compound varies depending on the position of the optically anisotropic layer in the thickness direction.

In addition, there are two types of twisted directions, but it does not matter whether the twisted direction is right-handed or left-handed. The right-twisted means that, in a case of being observed from one main surface of the optically anisotropic layer toward the other main surface, an in-plane slow axis is shifted clockwise with respect to the main surface on the observation side, which is a reference axis, toward the main surface on the opposite side.

The above-described twisted angle is measured using AxoScan (polarimeter) device of Axometrics, Inc. and using device analysis software of Axometrics, Inc.

The twisted angle of the liquid crystal compound can be appropriately adjusted by selecting the type of the liquid crystal compound, controlling the temperature during alignment and immobilization, and selecting the type and amount of the chiral agent.

In the specific retardation layer, it is preferable that both the first optically anisotropic layer and the second optically anisotropic layer are layers obtained by immobilizing a liquid crystal compound. In the liquid crystal compound, since liquid crystal molecules can be aligned in any orientation using an alignment film or the like, a manufacturing step of the specific retardation layer can be simplified.

In addition, in the specific retardation layer, it is preferable that an alignment direction of the liquid crystal compound contained in the first optically anisotropic layer and an alignment direction of the liquid crystal compound contained in the second optically anisotropic layer are continuous at an interface between the first optically anisotropic layer and the second optically anisotropic layer. With such a configuration, a difference in refractive index at the interface between the first optically anisotropic layer and the second optically anisotropic layer can be reduced, and interface reflection can be suppressed, so that disturbance in the polarization state of the ray transmitted through the specific retardation layer, due to the interface reflection, can be suppressed, and the ghost image can be further reduced.

In the present specification, the alignment directions of the liquid crystal compounds being continuous at the interface means that an in-plane slow axis on a surface of the first optically anisotropic layer on the second optically anisotropic layer side and an in-plane slow axis on a surface of the second optically anisotropic layer on the first optically anisotropic layer side are parallel to each other. That is, in a case where the alignment directions of the liquid crystal compounds are continuous at the interface, an angle between the in-plane slow axis on a surface of the first optically anisotropic layer on the second optically anisotropic layer side and the in-plane slow axis on a surface of the second optically anisotropic layer on the first optically anisotropic layer side is within 10° (0° to 10°).

It is preferable that, in the specific retardation layer, the first optically anisotropic layer is a positive A-plate, and the second optically anisotropic layer is the optically anisotropic layer RT obtained by immobilizing a twistedly aligned liquid crystal compound with a helical axis in a thickness direction. Here, the positive A-plate is a retardation layer in which Re has a certain value and Rth has a substantially 1/2 value of Re. The positive A-plate can be obtained, for example, by horizontally aligning rod-like liquid crystal compounds. The optically anisotropic layer RT is as described above, including a preferred aspect thereof.

In the specific retardation layer in which the first optically anisotropic layer is a positive A-plate and the second optically anisotropic layer is the optically anisotropic layer RT, it is preferable that the first optically anisotropic layer satisfies the following expression (1), in which a product of a refractive index anisotropy Δn1 at a wavelength of 550 nm and a thickness d1 is satisfied.

$$140 nm \leq Δ n 1 d 1 \leq 220 nm \qquad Expression ( 1 )$$

In addition, in the specific retardation layer in which the first optically anisotropic layer is a positive A-plate and the second optically anisotropic layer is the optically anisotropic layer RT, it is preferable that the second optically anisotropic layer satisfies the following expression (2), in which a product of a refractive index anisotropy Δn2 at a wavelength of 550 nm and a thickness d2 is satisfied.

$$150 nm \leq Δ n 2 d 2 \leq 230 nm \qquad Expression ( 2 )$$

Furthermore, the twisted angle of the second optically anisotropic layer is preferably 85°±20°.

In a case where the first optically anisotropic layer and the second optically anisotropic layer have the above-described configurations, the specific retardation layer can be set to a λ/4 retardation layer over a wider wavelength range.

The retardation layer as described above can refer to, for example, those described in WO2021/261435A.

Δn1d1 and Δn2d2 in the optically anisotropic layer are measured using AxoScan (polarimeter) device of Axometrics, Inc. and device analysis software manufactured by Axometrics, Inc., in the same manner as the measuring method of the twisted angle.

In addition, it is also preferable that, in the specific retardation layer, both the first optically anisotropic layer and the second optically anisotropic layer are layers (the optically anisotropic layers RT) obtained by immobilizing a twistedly aligned liquid crystal compound with a helical axis in a thickness direction. The optically anisotropic layer RT is as described above, including a preferred aspect thereof.

In a case where both the first optically anisotropic layer and the second optically anisotropic layer are the optically anisotropic layers RT, a helical pitch of the first optically anisotropic layer and a helical pitch of the second optically anisotropic layer may be the same or different from each other, but are preferably different from each other.

Here, the helical pitch of the optically anisotropic layer means a length in the thickness direction, in which the liquid crystal compound stacked in the optically anisotropic layer rotates once (rotates 360°) in a helical shape. The helical pitch of the optically anisotropic layer is calculated from the twisted angle and the thickness of the optically anisotropic layer by the following expression.

$$Helical pitch ( μ m ) = Thickness ( μ m ) / ( Twisted angle ( ° ) / 360 )$$

The helical pitch of the optically anisotropic layer can be adjusted by the twisted angle of the liquid crystal compound and the thickness of the optically anisotropic layer.

In a case where both the first optically anisotropic layer and the second optically anisotropic layer are the optically anisotropic layers RT, it is preferable that the first optically anisotropic layer satisfies the following expression (3), in which a product of a refractive index anisotropy Δn1 at a wavelength of 550 nm and a thickness d1 is satisfied.

$$252 nm \leq Δ n 1 d 1 \leq 312 nm \qquad Expression ( 3 )$$

In addition, in a case where both the first optically anisotropic layer and the second optically anisotropic layer are the optically anisotropic layers RT, the twisted angle of the first optically anisotropic layer is preferably 26.5°±10°.

Furthermore, in a case where both the first optically anisotropic layer and the second optically anisotropic layer are the optically anisotropic layers RT, it is preferable that the second optically anisotropic layer satisfies the following expression (4), in which a product of a refractive index anisotropy Δn2 at a wavelength of 550 nm and a thickness d2 is satisfied.

$$110 nm \leq Δ n 2 d 2 \leq 170 nm \qquad Expression ( 4 )$$

In addition, in a case where both the first optically anisotropic layer and the second optically anisotropic layer are the optically anisotropic layers RT, the twisted angle of the second optically anisotropic layer is preferably 78.6°±10°.

In a case where the first optically anisotropic layer and the second optically anisotropic layer have the above-described configurations, the specific retardation layer can be set to a λ/4 retardation layer over a wider wavelength range.

The retardation layer as described above can refer to, for example, those described in WO2021/261435A.

### [Manufacturing Method of Specific Retardation Layer]

(Manufacturing of specific retardation layer by adhesion of each layer)

A manufacturing method of the specific retardation layer is not particularly limited, and the specific retardation layer can be manufactured based on a known method.

The specific retardation layer may be manufactured by manufacturing the first optically anisotropic layer and the second optically anisotropic layer in separate steps, and then laminating the first optically anisotropic layer and the second optically anisotropic layer by bonding the first optically anisotropic layer and the second optically anisotropic layer to each other. The bonding can be performed using an adhesive layer such as an adhesive and a pressure sensitive adhesive.

From the viewpoint of suppressing the interface reflection, it is preferable that a refractive index of the adhesive layer between the layers is adjusted (refractive index matching) in accordance with the refractive index of each of the first optically anisotropic layer and the second optically anisotropic layer. In addition, a thickness of the adhesive layer can be appropriately set to suppress the interface reflection between the first optically anisotropic layer and the second optically anisotropic layer.

Furthermore, from the viewpoint of suppressing the interface reflection, it is also preferable that the adhesive layer between the layers has a thickness of 100 nm or less. In a case where the thickness of the adhesive layer is 100 nm or less, light in the visible region is not affected by the difference in refractive index, and extra reflection can be suppressed. The thickness of the adhesive layer is more preferably 50 nm or less.

Examples of a method of forming the adhesive layer having a thickness of 100 nm or less include a method of vapor-depositing a ceramic adhesive such as silicon oxide (SiOx layer) on an adhesive surface of the optically anisotropic layer. Before the adhesion, a surface modification treatment such as a plasma treatment, a corona treatment, and a saponification treatment can be performed on the adhesive surface of the optically anisotropic layer, and a primer layer can be applied. In addition, in a case where there are a plurality of adhesive surfaces of the optically anisotropic layer, the type and thickness of the adhesive layer can be adjusted for each adhesive surface.

Specifically, for example, the adhesive layer having a thickness of 100 nm or less can be provided by the procedures (1) to (3) described below.
(1) A layer to laminate is bonded to a temporary support consisting of a glass base material.
(2) An SiOx layer having a thickness of 100 nm or less is formed on both the surface of the layer to laminate and the surface of the layer to be laminated by vapor deposition or the like; the vapor deposition can be carried out by, for example, a vapor deposition device (model number ULEYES, manufactured by ULVAC, Inc.) using SiOx powder as a vapor deposition source; in addition, it is preferable that the surface of the formed SiOx layer is subjected to a plasma treatment.
(3) After the formed SiOx layers are bonded to each other, the temporary support is peeled off; it is preferable that the adhesion is carried out, for example, at a temperature of 120° C.

The application of the adhesive and the pressure sensitive adhesive to each layer, the formation of the adhesive layer such as the SiOx layer, and the adhesion may be performed by roll-to-roll or by single-wafer. The roll-to-roll method is preferable from the viewpoint of improving the productivity and reducing axis misalignment of each layer. Meanwhile, the single-wafer method is preferable from the viewpoints that this method is suitable for production of many kinds in small quantities and that a special adhesion method in which the thickness of the adhesive layer is 100 nm or less can be selected.

In addition, examples of the method of coating the adherend with the adhesive and the pressure sensitive adhesive include known methods such as a roll coating method, a gravure printing method, a spin coating method, a wire bar coating method, an extrusion coating method, a direct gravure coating method, a reverse gravure coating method, a die-coating method, a spraying method, and an inkjet method.

### (Manufacturing of Specific Retardation Layer by Direct Application of Each Layer)

It is also preferable that the first optically anisotropic layer and the second optically anisotropic layer do not have an adhesive layer therebetween. On the other hand, in a case of forming one optically anisotropic layer, the specific retardation layer having no adhesive layer between the first optically anisotropic layer and the second optically anisotropic layer can be manufactured by directly applying a composition for forming an optically anisotropic layer onto the other optically anisotropic layer which has already been formed.

Furthermore, in a case where one or both of adjacent layers are layers containing a liquid crystal compound, a difference in refractive index is reduced in all in-plane directions, and the ghost can be further reduced. Therefore, it is preferable to form the specific retardation layer in which the alignment direction of the liquid crystal compound continuously changes at the interface between the first optically anisotropic layer and the second optically anisotropic layer. For example, by directly applying a composition for forming the second optically anisotropic layer, containing a liquid crystal compound, onto the first optically anisotropic layer containing a liquid crystal compound, the liquid crystal compound of the second optically anisotropic layer can be aligned such that the alignment direction of the liquid crystal compound of both layers is continuous at the interface by an alignment restricting force of the liquid crystal compound of the first optically anisotropic layer.

### (Manufacturing of Specific Retardation Layer by Single Liquid Two-Layer Coating)

In addition, the first optically anisotropic layer and the second optically anisotropic layer can be formed by applying the same forming composition and then separating the layers into two layers by various methods. For example, the specific retardation layer can be manufactured by the following steps 1 to 5.
Step 1: a step of applying a polymerizable liquid crystal composition containing a chiral agent including a photosensitive chiral agent whose helical twisting power changes upon irradiation with light, and a reverse wavelength-dispersive liquid crystal compound having a polymerizable group (hereinafter, also simply referred to as “liquid crystal compound” in the description of the step 1 to the step 5) onto a support to form a composition layer
Step 2: a step of subjecting the composition layer to a heat treatment to align the liquid crystal compound in the composition layer
Step 3: a step of subjecting the composition layer after the step 2 to light irradiation under a condition of an oxygen concentration of 1% by volume or more
Step 4: a step of subjecting the composition layer after the step 3 to a heat treatment
Step 5: a step of subjecting the composition layer after the step 4 to a curing treatment to fix an alignment state of the liquid crystal compound, thereby forming the first optically anisotropic layer and the second optically anisotropic layer

The manufacturing steps of the retardation layer as described above can refer to, for example, steps described in WO2021/261435A.

A shape of the specific retardation layer may be planar or curved. In the virtual reality display apparatus, in order to correct aberration of a display image and to obtain a higher quality display, it is preferable that the surface shape of the lens base material is curved, and in this case, it is preferable that the specific retardation layer is also curved in accordance with the surface shape of the lens base material.

A thickness of the specific retardation layer is not particularly limited, but is preferably thin from the viewpoint of reducing the thickness of the virtual reality display apparatus. On the other hand, from the viewpoint of exhibiting desired optical performance, it is preferable to have a predetermined thickness. The thickness of the specific retardation layer is preferably 0.1 to 20 μm, more preferably 0.2 to 15 μm, and still more preferably 0.5 to 10 μm.

### <Laminated Optical Body>

The specific retardation layer may be laminated with other functional layers to be provided as a laminated optical body. Examples of the other functional layers include a polarizer such as a reflective linear polarizer, a reflective circular polarizer, and an absorptive polarizer. By laminating the polarizer, various optical functions of the virtual reality display apparatus can be integrated. As a result, the step of bonding the laminated optical body to the image display device or the lens base material can be performed only once, and thus the manufacturing cost can be reduced.

As the reflective linear polarizer, for example, a film stretched from a dielectric multi-layer film, a wire grid polarizer, and the like can be used.

As the reflective circular polarizer, for example, a reflective circular polarizer including a cholesteric liquid crystal layer can be used. The cholesteric liquid crystal layer is a layer having a liquid crystal phase in which the liquid crystal compound is in a cholesteric alignment state (cholesteric liquid crystalline phase). As the reflective circular polarizer including a cholesteric liquid crystal layer, a film or the like, obtained by curing a liquid crystal compound in a state exhibiting a cholesteric liquid crystalline phase, can be suitably used.

As the absorptive polarizer, a polarizer in which a polyvinyl alcohol film is stretched and an iodine complex is impregnated, and a polarizer in which a dichroic coloring agent is contained in a stretched polymer or a uniformly aligned liquid crystal compound can be used.

As the laminated optical body, a laminate including the specific retardation layer, the reflective linear polarizer or the reflective circular polarizer, and the absorptive polarizer is preferable. In a case where the laminated optical body includes the reflective linear polarizer, it is preferable that the absorptive polarizer, the reflective linear polarizer, and the specific retardation layer are arranged in this order; and in a case where the laminated optical body includes the reflective circular polarizer, it is preferable that the absorptive polarizer, the specific retardation layer, and the reflective circular polarizer are arranged in this order.

In addition, the laminated optical body can also include a functional layer different from the above-described polarizer for the purpose of further improving the optical action. Examples of the functional layer include a positive C-plate, an antireflection layer, an ultraviolet absorbing layer, and a hard coat layer. It is also preferable that the laminated optical body includes the functional layer.

The positive C-plate is a retardation layer in which the Re is substantially zero and the Rth has a negative value. The positive C-plate can be obtained, for example, by vertically aligning rod-like liquid crystal compounds. With regard to the details of the manufacturing method of the positive C-plate, reference can be made to the description in, for example, JP2017-187732A, JP2016-053709A, and JP2015-200861A.

The positive C-plate functions as an optical compensation layer for increasing the degree of polarization of the transmitted light with respect to light incident obliquely. A plurality of the positive C-plates may be provided at any position of the laminated optical body.

The positive C-plate may be provided adjacent to the specific retardation layer or inside the specific retardation layer. For example, in a case where a layer formed by immobilizing a rod-like liquid crystal compound is used as the specific retardation layer, the specific retardation layer has a negative Rth. Here, in a case where light is incident on the specific retardation layer in an oblique direction, the polarization state of the transmitted light may change due to the action of the Rth, and the degree of polarization of the transmitted light may decrease. In a case where the positive C-plate is provided inside the specific retardation layer and/or in the vicinity thereof, the change in polarization state of the oblique incident light is suppressed and the decrease in degree of polarization of the transmitted light can be suppressed, which is preferable.

It is preferable that the positive C-plate is disposed on a surface of the specific retardation layer on a side opposite to the reflective linear polarizer, but the positive C-plate may be disposed at another place. Re of the positive C-plate in this case is preferably approximately 10 nm or less, and Rth thereof is preferably −120 nm to −20 nm and more preferably −90 to −40 nm.

### [Support]

The laminated optical body may further include a support. The support can be provided at any position, and for example, in a case where the specific retardation layer is a film used by being transferred from the temporary support, the support can be used as a transfer destination thereof.

The type of the support is not particularly limited, but it is preferable that the support is transparent, and examples thereof include films made of cellulose acylate, polycarbonate, polysulfone, polyethersulfone, polyacrylate and polymethacrylate, cyclic polyolefin, polyolefin, polyamide, polystyrene, polyester, or the like. Among these, a cellulose acylate film, a cyclic polyolefin film, polyacrylate, a polyacrylate film, or a polymethacrylate film is preferable. In addition, commercially available cellulose acetate films (for example, “TD80U”, “Z-TAC”, and the like manufactured by FUJIFILM Corporation) can also be used.

It is preferable that the support has a small phase difference from the viewpoint of suppressing the effect on the degree of polarization of the transmitted light and viewpoint of facilitating the optical inspection of the laminated optical body. Specifically, a magnitude of Re is preferably 10 nm or less, and an absolute value of a magnitude of Rth is preferably 50 nm or less.

In a case where the laminated optical body is stretched or formed, it is preferable that the support has a tan & peak temperature of 170° C. or lower. From the viewpoint that the laminated optical body can be formed at a low temperature, the peak temperature of tan δ is preferably 150° C. or lower and more preferably 130° C. or lower.

Here, a method of measuring tan & will be described. E″ (loss elastic modulus) and E′ (storage elastic modulus) of a film sample which has been humidity-adjusted in advance in an atmosphere of a temperature of 25° C. and a humidity of 60% Rh for 2 hours or longer are measured under the following conditions using a dynamic viscoelasticity measuring device (DVA-200, manufactured by IT Measurement & Control Co., Ltd.), and the values are used to acquire tan δ (=E″/E′).
Device: DVA-200 manufactured by IT Measurement & Control Co., Ltd.
Sample: 5 mm, length of 50 mm (gap of 20 mm)
Measurement conditions: tension mode
Measurement temperature: −150° C. to 220° C.
Heating conditions: 5° C./min
Frequency: 1 Hz

Typically in optical applications, a resin base material subjected to a stretching treatment is frequently used, and the tan δ peak temperature is frequently increased due to the stretching treatment. For example, with a triacetyl cellulose (TAC) base material (TG40 manufactured by FUJIFILM Corporation), the peak temperature of tan δ is 180° C. or higher.

The support having a tan δ peak temperature of 170° C. or lower is not particularly limited, and various resin base materials can be used. Examples thereof include polyolefin such as polyethylene, polypropylene, and a norbornene-based polymer; a cyclic olefin-based resin; polyvinyl alcohol; polyethylene terephthalate; an acrylic resin such as polymethacrylic acid ester and polyacrylic acid ester; polyethylene naphthalate; polycarbonate; polysulfone; polyethersulfone; polyetherketone; polyphenylene sulfide, and polyphenylene oxide. Among these, from the viewpoint of being easily available on the market and having excellent transparency, a cyclic olefin-based resin, polyethylene terephthalate, or an acrylic resin is preferable, and a cyclic olefin-based resin or polymethacrylic acid ester is more preferable.

Examples of commercially available resin base materials include TECHNOLLOY S001G, TECHNOLLOY S014G, TECHNOLLOY S000, TECHNOLLOY C001, and TECHNOLLOY C000 (manufactured by Sumika Acryl Co., Ltd.), LUMIRROR U type, LUMIRROR FX10, and LUMIRROR SF20 (Toray Industries, Inc.), HK-53A (Higashiyama Film Co., Ltd.), TEFLEX FT3 (TOYOBO CO., LTD.), ESCENA and SCA40 (Sekisui Chemical Co., Ltd.), ZEONOR Film (ZEON CORPORATION), and an Arton Film (JSR Corporation).

A thickness of the support is not particularly limited, and is preferably 5 to 300 μm, more preferably 5 to 100 μm, and still more preferably 5 to 30 μm.

### <Lens>

The lens according to the first embodiment of the present invention is a composite lens including the above-described specific retardation layer.

The lens may include a lens base material, and preferably includes a lens base material. As a material of the lens base material, glass or a transparent resin is preferable.

It is preferable that the lens base material does not change a polarization state of rays, and it is preferable that the phase difference (Re and Rth) is zero.

The lens may include a layer other than the specific retardation layer and the lens base material described above. Examples of other layers include a half mirror, an antireflection layer, an ultraviolet absorbing layer, and a hard coat layer. Examples of the half mirror include a vapor-deposited film of a metal such as aluminum.

In addition, the lens may further include at least one polarizer selected from the group consisting of a reflective linear polarizer, a reflective circular polarizer, and an absorptive polarizer. These polarizers may be included in the above-described laminated optical body provided together with the specific retardation layer.

Among these, a lens including a reflective linear polarizer or a reflective circular polarizer, and an absorptive polarizer is preferable. In a case where the above-described reflective circular polarizer includes a cholesteric liquid crystal layer, it is preferable that the absorptive polarizer, the specific retardation layer, and the reflective circular polarizer are arranged in this order.

Specific configuration examples of the lens according to the first embodiment are as follows.
A lens including, in the following order: a reflective linear polarizer; a first retardation layer as the specific retardation layer; a lens base material; and a half mirror
A lens including, in the following order: an absorptive polarizer; a reflective linear polarizer; a first retardation layer as the specific retardation layer; a lens base material; and a half mirror
A lens including, in the following order: a first retardation layer as the specific retardation layer; a reflective linear polarizer; an absorptive polarizer; and a lens base material
A lens including, in the following order: a first retardation layer as the specific retardation layer; and a lens base material
A lens including, in the following order: an absorptive polarizer; a first retardation layer as the specific retardation layer; a reflective circular polarizer; a lens base material; and a half mirror
A lens including, in the following order: a reflective circular polarizer; a first retardation layer as the specific retardation layer; an absorptive polarizer; and a lens base material

Preferred aspects of each member included in the above-described configuration examples are as described above.

A shape of the lens base material is not particularly limited, but it is preferable that at least one surface thereof is a curved surface. In a case where the lens base material has a curved surface, in the virtual reality display apparatus, aberration of the display image can be corrected to provide a higher quality display. In addition, the curved surface may be a part of a spherical surface or may be an aspherical surface.

As the lens base material, a convex lens, a concave lens, a meniscus lens, or the like can be used. As the convex lens, a biconvex lens, a plano-convex lens, or a convex meniscus lens can be used. As the concave lens, a biconcave lens, a plano-concave lens, or a concave meniscus lens can be used.

### <Image Display Device>

The image display device according to the second embodiment of the present invention includes an image display panel, an absorptive polarizer, and the above-described specific retardation layer in this order.

Examples of the image display panel include an image display panel such as a liquid crystal display panel, an organic EL display panel, and a micro LED display panel.

It is preferable that the image display device according to the present embodiment includes an image display panel and an absorptive polarizer disposed on the image display panel, and the specific retardation layer disposed on an outer side of the absorptive polarizer, that is, a surface on a side where light is emitted. As a result, the image display device can emit ideal circularly polarized light.

The image display device according to the present embodiment includes at least an image display panel, an absorptive polarizer, and the specific retardation layer in this order. A preferred aspect of the specific retardation layer in the present embodiment is the same as that of the specific retardation layer included in the lens according to the first embodiment.

In addition, the image display device may include a known image display device member such as an antireflection layer, an ultraviolet absorbing layer, and a hard coat layer, in addition to the above-described specific retardation layer.

### <Virtual Reality Display Apparatus>

The virtual reality display apparatus according to the third embodiment of the present invention includes an image display device and a lens, in which at least one of a retardation layer included in the image display device or a retardation layer included in the lens is the specific retardation layer. As a result, the virtual reality display apparatus can suppress the occurrence of ghost image. The virtual reality display apparatus according to the present embodiment preferably includes at least one of the image display device according to the second embodiment or the lens according to the first embodiment.

In a case where the virtual reality display apparatus according to the present embodiment includes the lens according to the first embodiment, the image display device included in the virtual reality display apparatus may be the image display device according to the second embodiment or may be an image display device including a retardation layer different from the specific retardation layer. The image display device of the latter may have the same configuration as the image display device according to the second embodiment, except that the image display device includes the retardation layer different from the specific retardation layer, including a preferred aspect thereof.

In addition, in a case where the virtual reality display apparatus according to the present embodiment includes the image display device according to the second embodiment, the lens included in the virtual reality display apparatus may be the lens according to the first embodiment or may be a known lens including a retardation layer different from the specific retardation layer. The lens of the latter may have the same configuration as the lens according to the first embodiment, except that the lens includes the retardation layer different from the specific retardation layer, including a preferred aspect thereof. By including the image display device according to the second embodiment in the virtual reality display apparatus, in a case of assembling the lens, it is not necessary to precisely adjust an angle between the image display device and the lens, the lens assembly step can be simplified, and thus the manufacturing cost of the virtual reality display apparatus can be reduced.

It is preferable that the virtual reality display apparatus according to the present embodiment includes both the image display device according to the second embodiment and the lens according to the first embodiment. In addition, in this case, it is preferable that the specific retardation layer included in the image display device and the specific retardation layer included in the lens are substantially the same retardation layer. With such a configuration, it is possible to further reduce the occurrence of ghost in the virtual reality display apparatus.

The virtual reality display apparatus may further include an additional optical member such as a lens for aberration correction and a diopter-adjustment lens. The virtual reality display apparatus may further be equipped with various sensors using near-infrared light as a light source, such as eye tracking, expression recognition, and iris authentication.

The virtual reality display apparatus according to the present embodiment can be used as a glasses or goggles-type headset. In addition, the virtual reality display apparatus according to the present embodiment can be suitably used as an electronic view finder of a digital camera or an imager for a car-mounted display.

### EXAMPLES

Hereinafter, the features of the present invention will be described in more detail with reference to Examples. The materials, the used amounts, the proportions, the treatment contents, the treatment procedures, and the like described in Examples can be appropriately changed without departing from the gist of the present invention. In addition, configurations other than the configurations described below can be employed without departing from the gist of the present invention.

### [Production of Cellulose Acylate Film]

### (Production of Core Layer Cellulose Acylate Dope)

The following composition was put into a mixing tank and stirred to dissolve each component, thereby preparing a cellulose acetate solution used as a core layer cellulose acylate dope.

Core layer cellulose acylate dope

| | |
|---|---|
| Cellulose acetate having acetyl substitution degree of 2.88 | 100 parts by mass |
| Polyester compound B described in Examples of JP2015-227955A | 12 parts by mass |
| Compound F shown below | 2 parts by mass |
| Methylene chloride (first solvent) | 430 parts by mass |
| Methanol (second solvent) | 64 parts by mass |

Compound F

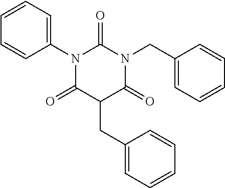 [SMILES: O=C1C(Cc2ccccc2)C(=O)N(c2ccccc2)C(=O)N1Cc1ccccc1]

### (Production of Outer Layer Cellulose Acylate Dope)

10 parts by mass of the following matting agent solution was added to 90 parts by mass of the core layer cellulose acylate dope to prepare a cellulose acetate solution to be used as an outer layer cellulose acylate dope.

Matting agent solution

| | | |
|---|---|---|
| Silica particles having an average particle | 2 | parts by mass |
| diameter of 20 nm (AEROSIL R972, | | |
| manufactured by Nippon Aerosil Co., Ltd.) | | |
| Methylene chloride (first solvent) | 76 | parts by mass |
| Methanol (second solvent) | 11 | parts by mass |
| Core layer cellulose acylate dope described above | 1 | part by mass |

### (Production of Cellulose Acylate Film 1)

The core layer cellulose acylate dope and the outer layer cellulose acylate dope were filtered through filter paper having an average hole diameter of 34 μm and a sintered metal filter having an average pore size of 10 μm, and three layers which were the core layer cellulose acylate dope and the outer layer cellulose acylate dopes provided on both sides of the core layer cellulose acylate dope were simultaneously cast from a casting port onto a drum at 20° C. (band casting machine).

Next, the film was peeled off in a state where the solvent content was approximately 20% by mass, both ends of the film in the width direction were fixed by tenter clips, and the film was dried while being stretched at a stretching ratio of 1.1 times in the lateral direction.

Thereafter, the film was further dried by being transported between the rolls of the heat treatment device to produce an optical film having a thickness of 40 μm, and the optical film was used as a cellulose acylate film 1 to be used as a temporary support for the specific retardation layer. An in-plane phase difference of the obtained cellulose acylate film 1 was 0 nm.

### [Formation of Retardation Layer]

### (Formation of Retardation Layer 1)

The cellulose acylate film 1 produced as described above was used as a temporary support.

The cellulose acylate film 1 was continuously coated with a coating liquid E1 for forming a photo-alignment film, having the following formulation, with a wire bar. The support on which the coating film had been formed was dried with hot air at 140° C. for 120 seconds, and the coating film was irradiated with polarized ultraviolet rays (10 mJ/cm², using an ultra-high pressure mercury lamp) to form a photo-alignment film E1 having a thickness of 0.2 μm, thereby obtaining a film with the photo-alignment film.

Coating liquid El for forming photo-alignment film

| | |
|---|---|
| Polymer PA-2 shown below | 100.00 parts by mass |
| Acid generator PAG-1 shown below | 5.00 parts by mass |
| Acid generator CPI-110TF shown below | 0.005 parts by mass |
| Isopropyl alcohol | 16.50 parts by mass |
| Butyl acetate | 1072.00 parts by mass |
| Methyl ethyl ketone | 268.00 parts by mass |

Acid generator CPI-110TF 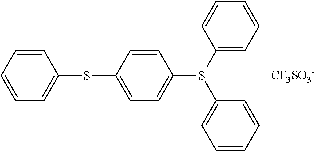
Polymer PA-2 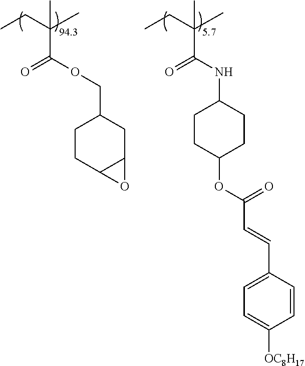
Acid generator PAG-1

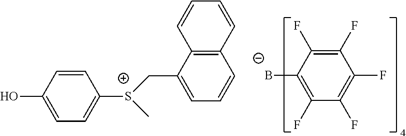

An optically anisotropic layer coating liquid (A) having the following formulation was applied onto the above-described photo-alignment film E1 using a bar coater, and heated at 80° C. for 60 seconds. Thereafter, the film on which the coating film was formed was irradiated with light of a metal halide lamp (manufactured by Eye Graphics Co., Ltd.) at an irradiation amount of 500 mJ and at 80° C. in a nitrogen atmosphere to fix the alignment state of the liquid crystal compound, thereby producing a second optically anisotropic layer A2.

A product Δnd of Δn and d of the second optically anisotropic layer A2 at a wavelength of 550 nm was 194 nm, and a twisted angle of the second optically anisotropic layer A2 was 85°. A thickness of the second optically anisotropic layer A2 was 4.1 μm. In addition, a molecular axis of the liquid crystal compound was horizontal to a surface of the cellulose acylate film (or a surface of the optically anisotropic layer).

### Formulation of Optically Anisotropic Layer Coating Liquid (A)

| | |
|---|---|
| Rod-like liquid crystal compound (A) shown below | 40 parts by mass |
| Rod-like liquid crystal compound (B) shown below | 40 parts by mass |
| Rod-like liquid crystal compound (C) shown below | 20 parts by mass |
| Ethylene oxide-modified trimethylolpropane triacrylate (V#360, manufactured by Osaka Organic | 4 parts by mass |
| Chemical Industry Ltd.) | |
| Photopolymerization initiator (IRGACURE 819, manufactured by Chiba Japan Co., Ltd.) | 3 parts by mass |
| Chiral agent (A) shown below | 0.46 parts by mass |
| Polymerizable polymer (X) shown below | 0.5 parts by mass |
| Polymer (A) shown below | 0.1 parts by mass |
| Methyl isobutyl ketone | 325 parts by mass |

Rod-like liquid crystal compound (A) 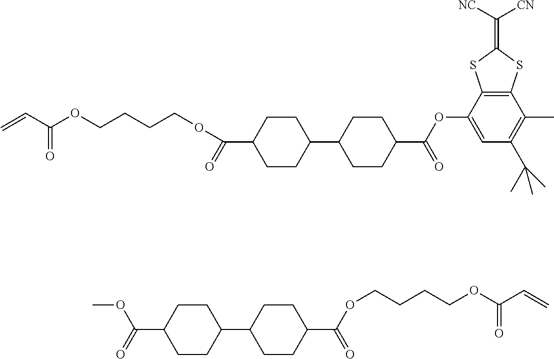
Rod-like liquid crystal compound (B) 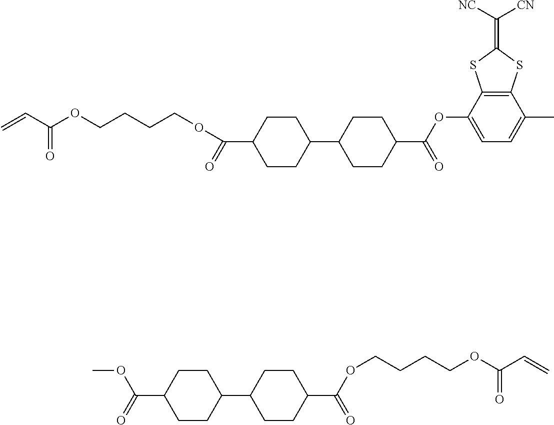
Rod-like liquid crystal compound (C) (corresponds to a mixture of liquid crystal compounds shown below) 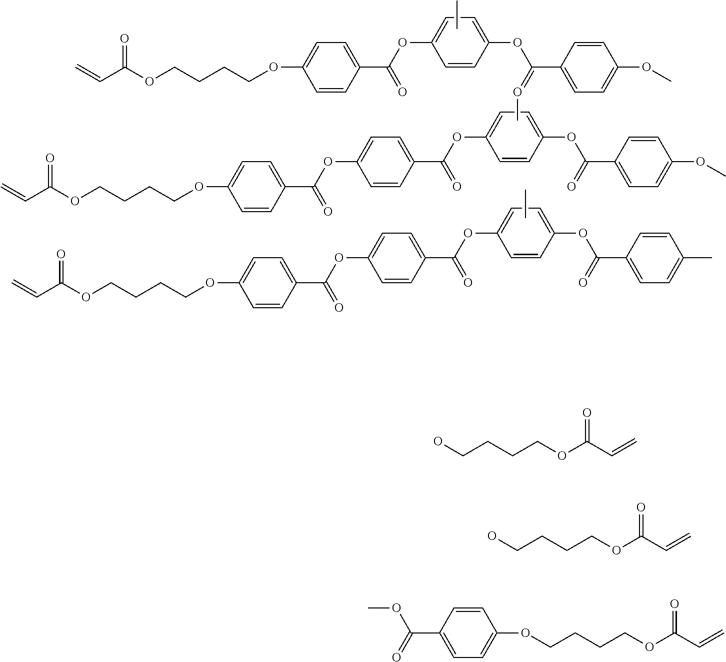
Chiral agent (A) 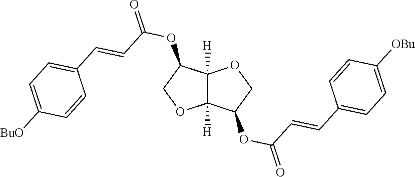
Polymerizable polymer (X) 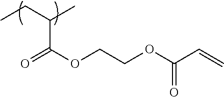
Polymer (A)

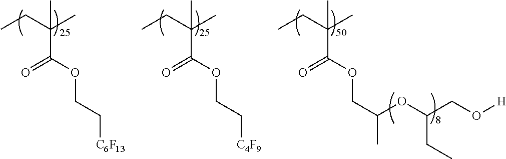

Next, a coating liquid in which the chiral agent (A) was removed from the above-described optically anisotropic layer coating liquid (A) was applied onto the above-described second optically anisotropic layer A2 using a bar coater, and heated at 80° C. for 60 seconds. Thereafter, the film on which the coating film was formed was irradiated with light of a metal halide lamp (manufactured by Eye Graphics Co., Ltd.) at an irradiation amount of 500 mJ and at 80° C. in a nitrogen atmosphere to fix the alignment state of the liquid crystal compound, thereby producing a first optically anisotropic layer A1.

The first optically anisotropic layer A1 was a positive A-plate in which a product Δnd of Δn and d at a wavelength of 550 nm was 205 nm, and a slow axis orientation of the first optically anisotropic layer A1 was the same as the orientation of the uppermost layer of the second optically anisotropic layer A2. A thickness of the first optically anisotropic layer A1 was 4.4 μm.

In this way, a retardation layer 1 including the cellulose acylate film 1 (temporary support), the photo-alignment film E1, the second optically anisotropic layer A2, and the first optically anisotropic layer A1 in this order was produced.

An in-plane phase difference of the retardation layer 1 was a value in a range of λ/4±5% in a range of a wavelength λ of 450 nm to 650 nm. In addition, both the first optically anisotropic layer A1 and the second optically anisotropic layer A2 had reverse wavelength dispersibility. That is, the retardation layer 1 was the specific retardation layer.

### (Formation of Retardation Layer 2)

A retardation layer 2, including the cellulose acylate film 1 (temporary support), the photo-alignment film E1, a second optically anisotropic layer B2, and a first optically anisotropic layer B1 in this order, was produced in the same manner as in the retardation layer 1, except that the film thickness of each optically anisotropic layer and the amount of the chiral agent (A) contained in each optically anisotropic layer were adjusted.

A product Δnd of Δn and d of the second optically anisotropic layer B2 in the retardation layer 2 at a wavelength of 550 nm was 157 nm, and a twisted angle thereof was 81°. In addition, a product Δnd of Δn and d of the first optically anisotropic layer B1 in the retardation layer 2 at a wavelength of 550 nm was 310 nm, and a twisted angle thereof was 24°. Furthermore, both the first optically anisotropic layer B1 and the second optically anisotropic layer B2 had reverse wavelength dispersibility.

An in-plane phase difference of the retardation layer 2 was a value in a range of λ/4±5% in a range of a wavelength λ of 450 nm to 650 nm. That is, the retardation layer 2 was the specific retardation layer.

### (Formation of Retardation Layer 3)

A coating liquid in which the chiral agent (A) was removed from the above-described optically anisotropic layer coating liquid (A) was applied onto the above-described photo-alignment film E1 using a bar coater, and heated at 80° C. for 60 seconds. Thereafter, the film on which the coating film was formed was irradiated with light of a metal halide lamp (manufactured by Eye Graphics Co., Ltd.) at an irradiation amount of 500 mJ and at 80° C. in a nitrogen atmosphere to fix the alignment state of the liquid crystal compound, thereby producing a retardation layer 3.

The retardation layer 3 was a positive A-plate in which a product Δnd of Δn and d at a wavelength of 550 nm was 141 nm. In addition, the retardation layer 3 had reverse wavelength dispersibility.

An in-plane phase difference of the retardation layer 3 was a value in a range of λ/4+5% in a range of a wavelength λ of 450 nm to 550 nm, but was out of the range of λ/4+5% at a wavelength λ of 650 nm.

### (Formation of Retardation Layer 4)

A retardation layer 4, including the cellulose acylate film 1, the photo-alignment film E1, a second optically anisotropic layer C2, and a first optically anisotropic layer C1 in this order, was produced according to the forming method of the retardation layer 1, except that an optically anisotropic layer coating liquid (A2) having the following formulation was used instead of the optically anisotropic layer coating liquid (A) in a case of producing the second optically anisotropic layer, and an optically anisotropic layer coating liquid from which the chiral agent (A) was removed from the optically anisotropic layer coating liquid (A2) was used instead of a coating liquid from which the chiral agent (A) was removed from the optically anisotropic layer coating liquid (A) in a case of producing the first optically anisotropic layer.

### Formulation of Optically Anisotropic Layer Coating Liquid (A2)

| | |
|---|---|
| Liquid crystal compound L-1 shown below | 70 parts by mass |
| Liquid crystal compound L-2 shown below | 30 parts by mass |
| Ethylene oxide-modified trimethylolpropane triacrylate | 4 parts by mass |
| (V#360, manufactured by Osaka Organic Chemical Industry Ltd.) | |
| Photopolymerization initiator (IRGACURE 819, manufactured by Chiba Japan Co., Ltd.) | 3 parts by mass |
| Chiral agent (A) shown below | 0.46 parts by mass |
| Polymerizable polymer (X) shown below | 0.5 parts by mass |
| Polymer (A) shown below | 0.1 parts by mass |
| Methyl ethyl ketone (solvent) | 200 parts by mass |
| Cyclopentanone (solvent) | 200 parts by mass |

Liquid crystal compound L-1 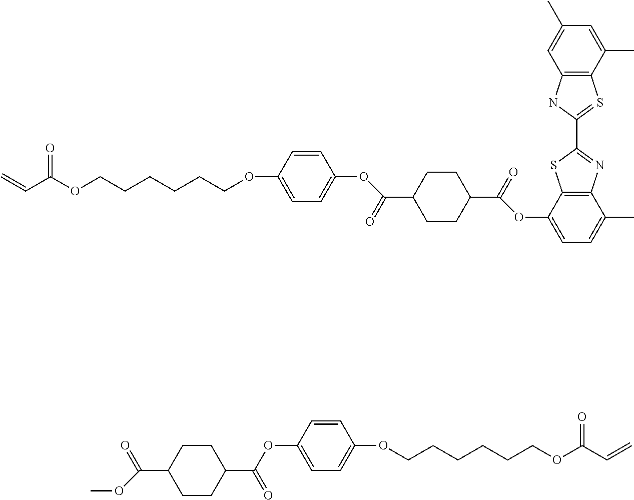
Liquid crystalline compound L-2 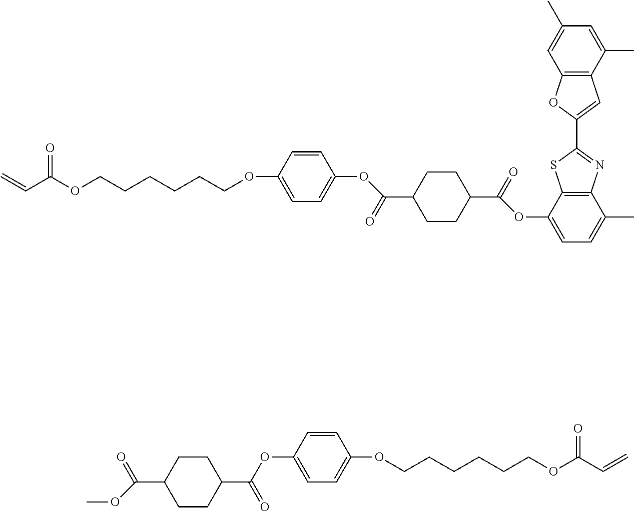
Polymerization initiator S-1

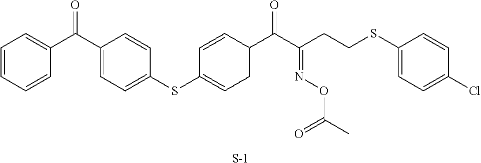

A product Δnd of Δn and d of the second optically anisotropic layer C2 at a wavelength of 550 nm was 194 nm, and a twisted angle thereof was 85°. In addition, a molecular axis of the liquid crystal compound was horizontal to a surface of the cellulose acylate film (or a surface of the optically anisotropic layer).

The first optically anisotropic layer C1 was a positive A-plate in which a product Δnd of Δn and d at a wavelength of 550 nm was 205 nm, and a slow axis orientation of the first optically anisotropic layer C1 was the same as the orientation of the uppermost layer of the second optically anisotropic layer C2.

In addition, both the first optically anisotropic layer C1 and the second optically anisotropic layer C2 had reverse wavelength dispersibility.

An in-plane phase difference of the retardation layer 4 was a value in a range of λ/4±5% in a range of a wavelength λ of 450 nm to 650 nm. That is, the retardation layer 4 was the specific retardation layer.

### [Production of Laminated Optical Body 1]

A liquid crystal display of a tablet computer “iPad (registered trademark)” manufactured by Apple Inc. was taken out, and a linear polarization type reflective polarizer (“APF”, trademark name of 3M Company) consisting of a broadband dielectric multi-layer film was peeled off from a polarizing plate bonded to a back surface of the liquid crystal display. Next, the retardation layer 1 was bonded to one surface of the peeled reflective polarizer APF using a pressure-sensitive adhesive sheet “NCF-D692 (5)” manufactured by LINTEC Corporation, and the temporary support of the retardation layer 1 was peeled off. In this case, a reflection axis orientation of the reflective polarizer APF and an effective slow axis orientation of the entire retardation layer 1 in the thickness direction were adjusted to be 45° with respect to each other.

Furthermore, an absorptive polarizer was bonded to a surface opposite to the reflective polarizer APF. In this case, the reflection axis orientation of the reflective polarizer APF and the absorption axis orientation of the absorptive polarizer were adjusted to be parallel to each other.

In this way, a laminated optical body 1 was obtained.

### [Production of Laminated Optical Bodies 2, 3, and 4]

Laminated optical bodies 2, 3, and 4 were produced in the same manner as described above, except that the retardation layer 1 was replaced with the retardation layer 2, the retardation layer 3, and the retardation layer 4, respectively.

### [Production of Lens 1]

A convex surface side of a plano-convex lens “#45-247 (manufactured by Edmund Optics, Inc.)” having a curved surface with a curvature radius of 65 mm was subjected to aluminum vapor deposition to form a half mirror. Next, the laminated optical body 1 was bonded to a flat surface side of the plano-convex lens using a pressure-sensitive adhesive sheet “NCF-D692 (15)” manufactured by LINTEC Corporation, such that the retardation layer 1 was on the plano-convex lens side.

In this manner, a lens 1 was produced.

### [Production of Lenses 2, 3, and 4]

Lenses 2, 3, and 4 were produced in the same manner as in the production method of the lens 1, except that the laminated optical body 1 was replaced with the laminated optical body 2, the laminated optical body 3, and the laminated optical body 4, respectively.

Table 1 shows the configurations of the lenses 1 to 4 produced as described above.

TABLE 1

| | Laminated optical body | | | |
|---|---|---|---|---|
| | | | | Orien- |
| | | | | tation |
| Lens | Number | Layer configuration | Axis | (°) |
| Lens 1 | 1 | Absorptive polarizer | Absorption axis | 0 |
| | | Reflective polarizer APF | Transmission axis | 0 |
| | | Retardation layer 1 | Slow axis | 45 |
| Lens 2 | 2 | Absorptive polarizer | Absorption axis | 0 |
| | | Reflective polarizer APF | Transmission axis | 0 |
| | | Retardation layer 2 | Slow axis | 45 |
| Lens 3 | 3 | Absorptive polarizer | Absorption axis | 0 |
| | | Reflective polarizer APF | Transmission axis | 0 |
| | | Retardation layer 3 | Slow axis | 45 |
| Lens 4 | 4 | Absorptive polarizer | Absorption axis | 0 |
| | | Reflective polarizer APF | Transmission axis | 0 |
| | | Retardation layer 4 | Slow axis | 45 |

### Example 1: Production of Virtual Reality Display Apparatus 1

A virtual reality display apparatus “Huawei (registered trademark) VR Glass” manufactured by Huawei Technologies Co., Ltd., which is a virtual reality display apparatus adopting a pancake lens, was disassembled, and all composite lenses (hereinafter, also referred to as “lens X”) disposed on the visible side were taken out. The lens 1 was assembled into a main body (that is, the “Huawei VR Glass” from which the lens X was taken out) instead of the taken-out lens X to produce a virtual reality display apparatus 1 of Example 1.

### Example 2: Production of Virtual Reality Display Apparatus 2

A virtual reality display apparatus 2 of Example 2 was produced in the same manner as in Example 1, except that the lens 1 was replaced with the lens 2.

### Example 3: Production of Virtual Reality Display Apparatus 3

The “Huawei VR Glass” was disassembled, and a built-in image display device (hereinafter, also referred to as “image display device X”) was taken out. An absorptive polarizer and a retardation layer consisting of a single optically anisotropic layer (hereinafter, also referred to as “retardation layer X”) were bonded to an liquid crystal display panel of the taken-out image display device X in this order. The above-described retardation layer X was peeled off from the image display device X, and the retardation layer 1 was bonded instead. In this case, an absorption axis of the above-described absorptive polarizer and an effective slow axis orientation of the entire retardation layer 1 in the thickness direction were adjusted to be 45°.

In this way, an image display device 1 including the liquid crystal display panel, the absorptive polarizer, and the retardation layer 1 in this order was produced.

The obtained image display device 1 was assembled into the “Huawei VR Glass” from which the image display device X was taken out to produce a virtual reality display apparatus 3 of Example 3.

### Example 4: Production of Virtual Reality Display Apparatus 4

A virtual reality display apparatus 4 of Example 4 was produced in the same manner as in Example 3, except that the retardation layer 1 was replaced with the retardation layer 2.

### Example 5: Production of Virtual Reality Display Apparatus 5

Both the lens X and the image display device X were taken out from the “Huawei VR Glass”. In the same manner as in Example 3, the retardation layer X was peeled off from the taken-out image display device X, and the retardation layer 1 was bonded instead to produce an image display device 1. In this case, an absorption axis of the above-described absorptive polarizer and an effective slow axis orientation of the entire retardation layer 1 in the thickness direction were adjusted to be 45°.

The obtained image display device 1 was assembled into the “Huawei VR Glass” from which the image display device X and the lens X were taken out, and then the above-described lens 1 was further assembled to produce a virtual reality display apparatus 5 of Example 5.

### Example 6: Production of Virtual Reality Display Apparatus 6

A virtual reality display apparatus 6 of Example 6 was produced in the same manner as in Example 5, except that the lens 1 was replaced with the lens 2, and the retardation layer 1 used in the image display device was replaced with the retardation layer 2.

### Example 7: Production of Virtual Reality Display Apparatus 7

Both the lens X and the image display device X were taken out from the “Huawei VR Glass”. In the same manner as in Example 3, the retardation layer X was peeled off from the taken-out image display device X, and the retardation layer 4 was bonded instead to produce an image display device 4. In this case, an absorption axis of the above-described absorptive polarizer and an effective slow axis orientation of the entire retardation layer 4 in the thickness direction were adjusted to be 45°.

The obtained image display device 4 was assembled into the “Huawei VR Glass” from which the image display device X and the lens X were taken out, and then the above-described lens 4 was further assembled to produce a virtual reality display apparatus 7 of Example 7.

### Comparative Example 1: Production of Virtual Reality Display Apparatus 8

A virtual reality display apparatus 8 of Comparative Example 1 was produced in the same manner as in Example 1, except that the lens 1 was replaced with the lens 3.

### Comparative Example 2: Virtual Reality Display Apparatus 9

The “Huawei VR Glass” was used as a virtual reality display apparatus 9 of Comparative Example 2. The “Huawei VR Glass” had the image display device X including a liquid crystal display panel, an absorptive polarizer, and the retardation layer X, and the lens X including a retardation layer consisting of a single optically anisotropic layer and a lens base material.

### <Evaluation of Ghost Visibility>

In each of the produced virtual reality display apparatuses, a black and white checkered pattern was displayed on the image display device. The virtual reality display apparatus was worn, the displayed black and white checkered pattern was visually observed, and ghost visibility was evaluated based on the following four-stage evaluation standard.
A: no ghost was visible, or ghost was slightly visible but not noticeable.
B: weak ghost was visible.
C: slightly strong ghost was visible.
D: strong ghost was visible.

Table 2 shows the configurations of the virtual reality display apparatuses of Examples and Comparative Examples, and the evaluation results thereof.

As shown in Table 2, in the virtual reality display apparatus according to the embodiment of the present invention, produced in each of Examples, the ghost visibility was favorable over the entire visual field region.

In addition, in a case of producing the virtual reality display apparatus, the lens was assembled by changing an angle between the slow axis of the retardation layer included in the image display device and the slow axis of the retardation layer included in the lens as viewed in a visible direction. As a result, it was found that, in the virtual reality display apparatus according to the embodiment of the present invention, produced in each of Examples, the ghost visibility evaluation did not change regardless of the angle in a case of assembling the lens.

TABLE 2

| | | | | | Ghost |
|---|---|---|---|---|---|
| | Image display device | | | Lens | visibility |
| Example 1 | Image display panel | Absorptive polarizer | Retardation layer X | Lens 1 | B |
| Example 2 | Image display panel | Absorptive polarizer | Retardation layer X | Lens 2 | B |
| Example 3 | Image display panel | Absorptive polarizer | Retardation layer 1 | Lens X | B |
| Example 4 | Image display panel | Absorptive polarizer | Retardation layer 2 | Lens X | B |
| Example 5 | Image display panel | Absorptive polarizer | Retardation layer 1 | Lens 1 | A |
| Example 6 | Image display panel | Absorptive polarizer | Retardation layer 2 | Lens 2 | A |
| Example 7 | Image display panel | Absorptive polarizer | Retardation layer 4 | Lens 4 | A |
| Comparative Example 1 | Image display panel | Absorptive polarizer | Retardation layer X | Lens 3 | D |
| Comparative Example 2 | Image display panel | Absorptive polarizer | Retardation layer X | Lens X | D |

As shown in the above table, it was found that the lens according to the embodiment of the present invention had an excellent effect of suppressing the occurrence of ghost in a case of being applied to a virtual reality display apparatus using a pancake lens (comparison between Examples 1 and 2 and Comparative Examples 1 and 2).

In addition, it was found that the image display device according to the embodiment of the present invention had an excellent effect of suppressing the occurrence of ghost in a case of being applied to a virtual reality display apparatus using a pancake lens (comparison between Examples 3 and 4 and Comparative Examples 1 and 2).

Furthermore, it was found that the virtual reality display apparatus according to the embodiment of the present invention had an excellent effect of suppressing the occurrence of ghost (comparison between Examples 1 to 7 and Comparative Examples 1 and 2).

Among these, from the comparison between Examples 1 to 4 and Examples 5 to 7, it was found that, in a case where the virtual reality display apparatus had both the lens according to the embodiment of the present invention and the image display device according to the embodiment of the present invention, the effect of suppressing the occurrence of ghost was more excellent.

### EXPLANATION OF REFERENCES

1, 1000: virtual reality display apparatus
2: lens
3, 500: image display device
10: ray forming main image
11, 12: ray forming ghost image
21, 100: reflective linear polarizer
22, 200: first retardation layer
23, 600: lens base material
24, 300: half mirror
31, 400: second retardation layer
32: absorptive polarizer
33: image display panel

What is claimed is:

1. A lens comprising:
a retardation layer which converts circularly polarized light into linearly polarized light,
wherein the retardation layer includes a first optically anisotropic layer and a second optically anisotropic layer,
the first optically anisotropic layer and the second optically anisotropic layer have reverse wavelength dispersibility, and
at least one of the first optically anisotropic layer or the second optically anisotropic layer is a layer obtained by immobilizing a twistedly aligned liquid crystal compound with a helical axis in a thickness direction.

2. The lens according to claim 1,
wherein both the first optically anisotropic layer and the second optically anisotropic layer are layers obtained by immobilizing a liquid crystal compound.

3. The lens according to claim 2,
wherein an alignment direction of the liquid crystal compound contained in the first optically anisotropic layer and an alignment direction of the liquid crystal compound contained in the second optically anisotropic layer are continuous at an interface between the first optically anisotropic layer and the second optically anisotropic layer.

4. The lens according to claim 1,
wherein the first optically anisotropic layer is a positive A-plate, and the second optically anisotropic layer is a layer obtained by immobilizing a twistedly aligned liquid crystal compound with a helical axis in a thickness direction.

5. The lens according to claim 1,
wherein both the first optically anisotropic layer and the second optically anisotropic layer are layers obtained by immobilizing a twistedly aligned liquid crystal compound with a helical axis in a thickness direction, and
a helical pitch of the first optically anisotropic layer is different from a helical pitch of the second optically anisotropic layer.

6. The lens according to claim 1, further comprising:
a reflective linear polarizer.

7. The lens according to claim 1, further comprising:
a reflective circular polarizer.

8. The lens according to claim 7,
wherein the reflective circular polarizer has a cholesteric liquid crystal layer.

9. The lens according to claim 6, further comprising:
an absorptive polarizer.

10. A virtual reality display apparatus comprising:
an image display device; and
the lens according to claim 1.

11. An image display device comprising, in the following order:
an image display panel;
an absorptive polarizer; and
a retardation layer which converts circularly polarized light into linearly polarized light,
wherein the retardation layer includes a first optically anisotropic layer and a second optically anisotropic layer,
the first optically anisotropic layer and the second optically anisotropic layer have reverse wavelength dispersibility, and
at least one of the first optically anisotropic layer or the second optically anisotropic layer is a layer obtained by immobilizing a twistedly aligned liquid crystal compound with a helical axis in a thickness direction.

12. The image display device according to claim 11,
wherein both the first optically anisotropic layer and the second optically anisotropic layer are layers obtained by immobilizing a liquid crystal compound.

13. The image display device according to claim 12,
wherein an alignment direction of the liquid crystal compound contained in the first optically anisotropic layer and an alignment direction of the liquid crystal compound contained in the second optically anisotropic layer are continuous at an interface between the first optically anisotropic layer and the second optically anisotropic layer.

14. The image display device according to claim 11,
wherein the first optically anisotropic layer is a positive A-plate, and the second optically anisotropic layer is a layer obtained by immobilizing a twistedly aligned liquid crystal compound with a helical axis in a thickness direction.

15. The image display device according to claim 11,
wherein both the first optically anisotropic layer and the second optically anisotropic layer are layers obtained by immobilizing a twistedly aligned liquid crystal compound with a helical axis in a thickness direction, and
a helical pitch of the first optically anisotropic layer is different from a helical pitch of the second optically anisotropic layer.

16. A virtual reality display apparatus comprising:
a lens; and
the image display device according to claim 11.

17. A virtual reality display apparatus comprising:
the lens according to claim 1; and
an image display device comprising, in the following order,
an image display panel,
an absorptive polarizer, and
a retardation layer which converts circularly polarized light into linearly polarized light,
wherein the retardation layer includes a first optically anisotropic layer and a second optically anisotropic layer,
the first optically anisotropic layer and the second optically anisotropic layer have reverse wavelength dispersibility, and
at least one of the first optically anisotropic layer or the second optically anisotropic layer is a layer obtained by immobilizing a twistedly aligned liquid crystal compound with a helical axis in a thickness direction.

18. The lens according to claim 2,
wherein the first optically anisotropic layer is a positive A-plate, and the second optically anisotropic layer is a layer obtained by immobilizing a twistedly aligned liquid crystal compound with a helical axis in a thickness direction.

19. The lens according to claim 2,
wherein both the first optically anisotropic layer and the second optically anisotropic layer are layers obtained by immobilizing a twistedly aligned liquid crystal compound with a helical axis in a thickness direction, and
a helical pitch of the first optically anisotropic layer is different from a helical pitch of the second optically anisotropic layer.

20. The lens according to claim 2, further comprising:
a reflective linear polarizer.
